(19) United States
(12) Patent Application Publication
(10) Pub. No.: US 2005/0270533 A1
(43) Pub. Date: Dec. 8, 2005

(54) Method and apparatus for the colorimetric measurement of effect and solid-color paints

(75) Inventor: Peter Hoffmann, Senden (DE)

Correspondence Address: BASF CORPORATION;ANNE GERRY SABOURIN, 26701 TELEGRAPH ROAD, SOUTHFIELD, MI, 48034-2442, US

(73) Assignee: BASF Coatings Aktiengesellschaft, Munster (DE)

(21) Appl. No.: 11/119,583

(22) Filed: May 2, 2005

(30) Foreign Application Priority Data
Jun. 4, 2004 (DE) 10 2004 027 448.7

(51) Int. Cl. G01J 3/46

(52) U.S. Cl. 356/407; 356/402

(57) ABSTRACT

In the method and apparatus for the colorimetric measurement of effect and solid-color paints, light from a light source (1) irradiates at least one detection area (2) on a painted measured area (4) of a sample (3) and the light reflected from the measured area (4) of the sample (3) is received by a two-dimensional detector (5). The illumination and the detection angles are adjusted with respect to each other relative to the measured area and RGB values of the light received by the two-dimensional detector for a plurality of angles are registered as a function of the illumination and detection angle and supplied to a data-processing device. By means of a data processing program, the data sets obtained in this way are assigned to the 3-D data of a virtual three-dimensional substrate, in particular a virtual automobile body or its parts, at a virtual illumination and viewing angle of the virtual substrate and are visualized by means of a reproduction device.

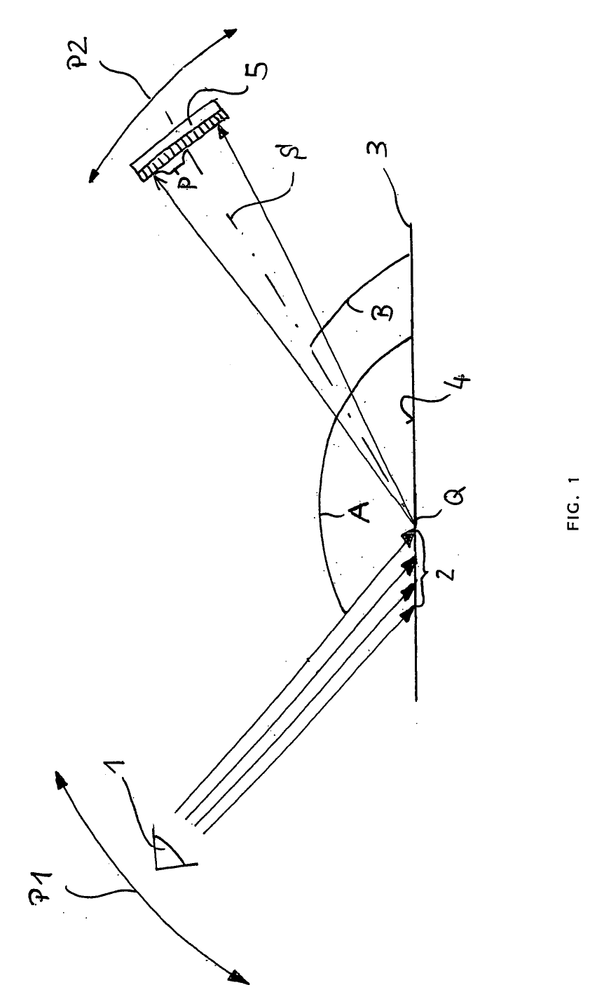

The invention relates to a method and an apparatus for the calorimetric measurement in particular of effect and solid-color paints.

In the automobile industry, with the introduction of fitted parts painted in the color of the automobile, color measurement based on a spectrophotometric data has made progress. This calorimetric data is used in quality assurance in order to replace the often subjective color assessment carried out by human beings.

On account of technical boundary conditions, color measurement by means of transportable color measuring instruments which operate with fixed illumination and three to five discrete viewing angles (X-Rite) has made progress. These measured values can be used as a quality tool, as has been shown in many automobile painting facilities; however, no conclusions about the color impression on the vehicle can be derived from these.

In particular when defining limiting values for the quality tools, the visual impression is therefore still critical. Likewise, the effect of a color on the vehicle to be painted cannot be described adequately by using what is known as a “5-angle measurement”.

For the purpose of more exact description of a color, use is also made of known laboratory instruments, in which illumination and detector can be aligned with respect to each other in such a way that, in theory, all the color reflections picked up by the human eye can be recorded. However, a measurement of this type is very complicated and cannot be used as a routine measurement.

The requirements on the visual appearance of the painted outer skin parts of automobiles, which are often different in terms of materials, have risen continuously in the recent past. The most important criterion, apart from a constant gloss over the entire bodywork, is the color. Original color patterns are in this case used as a reference for painting lines and suppliers.

In order to check the reproducibility of a defined color, in the recent past color measurement has become considerably more widespread and gained considerably in importance, in particular as a result of the development of portable measuring instruments.

In this case, the measurements are carried out with a defined geometry of the observer with respect to the light source. Measuring systems which comprise spectrophotometers which supply partially discrete values are widespread, although these values are recorded only at a few points in the case of a few selected bodies. Spectrophotometers of this type are capable of measuring the intensities of individual wavelengths, on the basis of which color values for types of light not used directly can also be calculated.

In order to assess the color, the CIE L*a*b* color space (also called the CIE system) has been proved to be worthwhile. Here, the color can be described in numerical values as L* (lightness), a* (green-red axis) and b* (blue-yellow axis). The L*, a* and b* values are calculated from the reflectance values of the spectrophotometer measurements, the normal spectral value functions and the radiation distribution of the type of light used. It is known to determine these values at 3 to 5 different angles for one measured point. Partially discrete values are registered, although they are recorded only at a few points in the case of a few selected bodies. As a result of the normally manual treatment, a great deal of expenditure of time is necessary. In addition, the measurements can be affected by errors as a result of the changing conditions.

In the case of such multi-angle spectrophotometers, the alignment of the measuring unit parallel to the tangent to the object surface is very important, since only in this way can the angle of the measuring geometry be positioned exactly. Since this is possible only up to a certain limiting radius in the case of curved surfaces, planar samples are preferably used in the case of spectrophotometers of this type. As a result of reduction to a few items of information, the color information obtained with these measured values can be determined on virtual displays (automobiles) only by means of extrapolation of the intermediate values. The virtual display is therefore not comparable with the true information.

A flat color measurement would therefore be desirable. A rapid comparison between the color detected over the entire body and the data from an original body color stored in the computer would be possible. By this means, the measuring speed and therefore the number of series of bodies considered for quality assurance would additionally also be increased. Moreover, statements about possible painting faults and the cloudiness of a painted surface could additionally be made.

It has been shown that the evaluation of measurements known at present does not permit adequate color assessment on curved surfaces. In particular, effect paints cannot be simulated and assessed adequately in this way.

WO 02/082063 A1 discloses a method in which light from a light source irradiates at least one detection area on a painted sample and the light is received by a two-dimensional detector. In this case, the illumination and detection angles are adjusted with respect to each other relative to the measured area and the RGB values of the light received by the two-dimensional detector for a plurality of angles are registered as a function of the illumination and detection angle and supplied to a data-processing device. The data obtained in this way can be compared with that from a color database for the purpose of formulating the composition of a color.

The manner in which a specific color formulation acts on a three-dimensional substrate of an actual shape cannot be determined by this method.

The invention is therefore based on the object of providing a method of color measurement with which an adequately accurate color assessment can be carried out and visualized, even in the case of effect paints, with regard to the visual impression imparted by the effect paint on a three-dimensional substrate of actual shape.

This object is achieved by the method reproduced in claim 1 and the apparatus for applying the method reproduced in claim 10.

In the method as claimed in the invention, a preferably planar painted surface is illuminated by means of a light source, for example from a halogen lamp. The red-green-blue values (RGB values) of the light reflected from the painted surface are registered with the aid of a two-dimensional sensor, which preferably operates using CCD technology, and led to a data-processing device. Here, the RGB values are assigned to the associated illumination and detection angles. The data sets obtained in this way are converted by means of rendering data processing programs known per se to the 3-D data of a virtual three-dimensional substrate, in particular to the 3-D data of a virtual automobile body or the parts of the latter, as function of illumination and viewing angles. The color values determined are depicted on an optical reproduction device, for example on a monitor. The optical impression imparted by the virtual three-dimensional substrate can thus be displayed as a function of illumination and viewing angles by using the measurement on only one sample.

The advantages and preferred developments of the method as claimed in the invention are to be explained in the following text using the example of automobile bodywork. It goes without saying that parts of the bodywork or else other three-dimensional substrates can take the place of the bodywork.

As a result of using what is known as a CCD chip as detector and an IT-controlled system, the illumination and detector positions are adjusted with respect to each other in such a way that a sufficient number of measured data are available which then, via known software, permit a virtual display of a body painted with this color. For this display, access to the 3-D data from the bodywork is necessary. On the basis of this surface data, the data set determined by means of the aforementioned measuring apparatus can be transferred to the virtual bodywork with the aid of known rendering software.

Furthermore, quality questions which occur daily on the basis of the organization participating in the operations of the automobile manufacturer can be clarified: the painting of fitted parts in the color of the automobile is often carried out outside the factory responsible for the painting of the bodywork. For the assessment of a color deviation of the fitted part, it is as a rule necessary for what is known as a fitting trial to be carried out. For as long as no statement is made by means of this trial, the production (painting) of these fitted parts cannot continue, and high failure rates of machine occupancy times often arise as a result. With the aid of the aforementioned measuring apparatus, the color quality of this deviating component can be fitted virtually to a body projected on a calibrated monitor and can be assessed significantly better than is currently conventional by using a short measurement. At the same time, this deviation can be assessed in comparison with other factories which may possibly likewise employ this component. This assessment is necessary since the various paint shops as a rule yield different color results for the same color.

The particular advantage of this method also resides, inter alia, in the fact that effects of changes in the shape of the automobile bodywork on the visual impression imparted by a specific color can be displayed by using the virtual automobile bodywork. In this way, for example, design changes which would have a detrimental effect on the visual impression imparted by the automobile bodywork in the case of specific colors can be avoided.

In addition, the method can be employed in order to display to customers how a specific color acts on a specific automobile body, which has hitherto not been possible by using the small color samples which are usually available. “Nasty surprises” with regard to the visual impression imparted by the selected color can be avoided in this way.

Furthermore, it is possible to predict whether fitted parts which, for example, have been painted at another location and therefore can exhibit color differences, will match a painted automobile body. For this purpose, the data sets from the automobile body and from the fitted parts are recorded in accordance with the method as claimed in the invention on parallel-painted samples and converted to the virtual body or the virtual fitted parts. Thus, via a virtual fitting trial, the quality of the painting can be assessed.

The method is preferably calibrated by the result of a measurement carried out in accordance with the above-mentioned method being compared with a true body painted in the same color in a defined environment, for example a presentation room. Trials have shown that, using the method as claimed in the invention, the visual impression imparted by an automobile body can be displayed reliably for virtually any colors if the calibration is carried out for only one specific color.

The measured area is preferably planar. The registration of the RGB values at various illumination and detection angles can then be carried out by the light source and/or the two-dimensional sensor being displaced semicircularly over the planar painted area.

If the measurement, as preferred, is carried out on the painted area at least at virtually all possible illumination and viewing angles, then the visual impression imparted by the body can also be displayed particularly well by means of the method as claimed in the invention as a function of the position of the viewer in relation to the body and the angle of incidence of the light since, by means of the data-processing program, each point of the body, which is present in electronic form, preferably in CAD data, can be assigned corresponding angular data.

If a CCD sensor is used as two-dimensional sensor, then each pixel has a specific position in relation to the respective viewing angle. Integration over a plurality of pixels and the generation of redundant analysis data are therefore possible. In addition, with the measuring arrangement as claimed in the invention, a statement about what is known as “sparkling” is made via the scatter of the measured data over the area viewed.

In order to restrict the data-processing effort, the bodywork can be subdivided into areas with different illumination and viewing angles. It has been shown that a good reproduction of the color impression is achieved if, for this purpose, the body is divided up into triangular areas which are at different angles in relation to the viewer.

Scaled numerical values can be defined as RGB values for defining the color reproduction of a pixel on the reproduction device.

If, as particularly preferred, the two-dimensional detector axis is also displaced relative to the sample and if, in this case, color measured values are recorded, then the color impression can be determined as a function of the painting direction, also called the azimuth.

The apparatus suitable for applying the method comprises a light source and a two-dimensional sensor, which can be displaced relative to a planar painted measured area of a sample in such a way that the light reflected from the detection area can be received at various illumination and viewing angles. Furthermore, the apparatus comprises a data-processing device for the storage and assignment of the RGB values received by the two-dimensional sensor as a function of the positions of the light source (illumination angle) and the two-dimensional sensor (detection angle). By using the data-processing device, the data sets obtained in this way are assigned to the 3-D data of a virtual three-dimensional substrate, in particular a virtual automobile body or parts thereof, at a virtual illumination and viewing angle of the virtual substrate.

The two-dimensional sensor used in the apparatus can comprise a detector operating digitally which, particularly preferably, can be configured as a CCD chip.

The configuration as a CCD chip is particularly advantageous, since a CCD sensor splits the irradiated light into the colors red, green, blue for the purpose of color reproduction. The RGB values obtained in this way can be supplied directly to the data processing program.

In order to split the light, different technical concepts, for example the 3-chip, the X3-chip or the 1-chip technique with a color filter mosaic have become established in practice. All the technologies are in principle suitable for the application of the method as claimed in the invention.

The light source and the two-dimensional sensor are preferably arranged and mounted in such a way that they can be displaced on circular arcs. However, it is likewise possible to record the reflected light from a plurality of detectors which are arranged semicircularly with respect to the sample. The measuring times can thus be reduced. Furthermore, it is then possible to illuminate only briefly, for example in the manner of a flashlight.

The intention is now to be clarified by using the appended drawing.

From a light source 1, light is radiated onto a detection area 2 of a sample 3 which has a planar painted surface 4. The light reflected from the detection area is picked up by a two-dimensional detector 5, which is configured as a CCD chip. Both the light source 1 and the detector 5 can be displaced relative to each other and relative to the detection area 2, as is intended to be symbolized by the arrows P1 and P2.

For each point Q of the detection area 2 there are then N viewing angles, which have to be calculated from the illumination angle A and the viewing angle B. Each pixel 6 of the two-dimensional detector 5 is assigned a specific position P in relation to the viewing angle B.

For each illumination angle A and viewing angle B, the RGB values registered by the individual pixels are supplied to a data-processing system, not illustrated in the drawing, and, by means of a commercially available data processing program known from computer gaming technology, are assigned to a virtual body as a function of the corresponding viewing angle. The image which results in this way is visualized by means of a monitor, likewise not illustrated in the drawing.

1. A method for the colorimetric measurement of effect and solid-color paints,
in which light from a light source (1) irradiates at least one detection area (2) on a painted measured area (4) of a sample (3) and the light reflected from the measured area (4) of the sample (3) is received by a two-dimensional detector (5),
wherein the illumination and the detection angles are adjusted with respect to each other relative to the measured area and RGB values of the light received by the two-dimensional detector for a plurality of angles are registered as a function of the illumination and detection angle and supplied to a data-processing device,
and wherein, by means of a data processing program, the data sets obtained in this way are assigned to the 3-D data of a virtual three-dimensional substrate, in particular a virtual automobile body or its parts, at a virtual illumination and viewing angle of the virtual substrate and are visualized by means of a reproduction device.

2. The method as claimed in claim 1, wherein a commercially available rendering program is used as the data-processing program.

3. The method as claimed in claim 1, wherein the calibration of the method is carried out by comparing a measurement carried out in accordance with the method with a true three-dimensional substrate painted in the same color, in particular a true automobile body, in a defined environment.

4. The method as claimed in claims 1, wherein the light is radiated onto a planar detection area (2) on a painted measured area (4) of a sample (3).

5. The method as claimed in claim 4, wherein the light source and/or the two-dimensional sensor are displaced semicircularly over the detection area (2).

6. The method as claimed in claim 1, wherein the two-dimensional sensor used is a CCD sensor.

7. The method as claimed in claim 1, wherein the virtual three-dimensional substrate, in particular the virtual automobile body or its parts, are subdivided into areas with different illumination and viewing angles and the areas are assigned color values picked up at corresponding angles.

8. The method as claimed in claim 1, wherein the RGB values are defined as scaled numerical values for defining the color reproduction of a pixel on the reproduction device.

9. The method as claimed in claim 1, wherein the two-dimensional detector axis (S) is displaced relative to the sample.

10. The method as claimed in claim 1, wherein the reflected light is picked up by a plurality of detectors which are arranged semicircularly in relation to the sample.

11. An apparatus for applying the method as claimed in claim 1,
having a light source (1) which can be displaced relative to a measured area (4) of a sample (3) in order to change the illumination angle,
having a two-dimensional detector (5) for picking up the RGB values of the light reflected from the detection area (2), wherein the two-dimensional detector (5) can be displaced relative to the measured area (4) independently of the light source (1), in such a way that the light reflected from the detection area (2) can be received at different detection angles,
having a data-processing device for the storage and assignment of the RGB values to the associated illumination and detection angles and for the assignment of the data sets obtained in this way to the 3-D data of a virtual three-dimensional substrate, in particular a virtual automobile body or its parts, at a virtual illumination and viewing angle of the virtual substrate, and
having a reproduction device for visualizing the three-dimensional substrate.

12. The apparatus as claimed in claim 11, wherein the two-dimensional detector (5) comprises a detector operating digitally.

13. The apparatus as claimed in claim 12, wherein the two-dimensional detector comprises a CCD chip.

14. The apparatus as claimed in claim 11, wherein the light source (1) is mounted in such a way that it can be displaced in a circular arc.

15. The apparatus as claimed in claim 11, wherein the image recording device (5) is mounted in such a way that it can be displaced in a circular arc.

16. The apparatus as claimed in claim 11, wherein the reproduction device comprises a monitor.
